(19) United States
(12) Patent Application Publication
(10) Pub. No.: US 2024/0304370 A1
(43) Pub. Date: Sep. 12, 2024

(54) IRON CORE MAGNETIC CIRCUIT MULTIPLEXING METHOD

(71) Applicant: CRRC ZHUZHOU ELECTRIC LOCOMOTIVE RESEARCH INSTITUTE CO., LTD., Zhuzhou, Hunan (CN)

(72) Inventors: Gaohua CHEN, Zhuzhou, Hunan (CN); Rongjun DING, Zhuzhou, Hunan (CN); Jianghua FENG, Zhuzhou, Hunan (CN); Kean LIU, Zhuzhou, Hunan (CN); Jing SHANG, Zhuzhou, Hunan (CN); Haitao LIU, Zhuzhou, Hunan (CN); Yijing XU, Zhuzhou, Hunan (CN); Yu SHI, Zhuzhou, Hunan (CN); Yu WANG, Zhuzhou, Hunan (CN); Wenlong ZHANG, Zhuzhou, Hunan (CN); Zhuxia FAN, Zhuzhou, Hunan (CN); Liang HAN, Zhuzhou, Hunan (CN)

(73) Assignee: CRRC ZHUZHOU ELECTRIC LOCOMOTIVE RESEARCH INSTITUTE CO., LTD., Zhuzhou, Hunan (CN)

(21) Appl. No.: 18/275,915

(22) PCT Filed: Sep. 29, 2021
(86) PCT No.: PCT/CN2021/121594

§ 371 Date: Aug. 4, 2023

(30) Foreign Application Priority Data
Feb. 4, 2021 (CN) 202110166845.8

(51) Int. Cl. H01F 27/24; H01F 7/06; H01F 27/30; H01Q 7/06; H02K 1/06

(52) U.S. Cl. CPC H01F 27/24; H01F 7/066; H01F 27/306; H01Q 7/06; H02K 1/06

(57) ABSTRACT

An iron core magnetic circuit multiplexing method. An iron core magnetic circuit is multiplexed into a common channel for any periodic function power electromagnetic field and signal electromagnetic wave and a combination thereof, so as to construct an iron core superspace; and the iron core superspace can accommodate any one or more power electromagnetic fields and signal electromagnetic waves, so that an iron core becomes a carrier of a multifunctional channel to achieve the purpose of implementing multifunctional expansion and integrated application. The iron core magnetic circuit multiplexing method comprises: using an iron core as a magnetic circuit multiplexing channel of any periodic function power electromagnetic field and signal electromagnetic wave and a combination thereof; and constructing the magnetic circuit multiplexing channel into an iron core superspace, wherein the iron core superspace can accommodate any one or more power electromagnetic fields and signal electromagnetic waves.

This application claims the priority to Chinese Patent Application No. 202110166845.8, titled “IRON CORE MAGNETIC CIRCUIT MULTIPLEXING METHOD”, filed on Feb. 4, 2021 with the China National Intellectual Property Administration, which is incorporated herein by reference in its entirety.

### FIELD

The present disclosure relates to the field of electric drive and automation, and in particular to a method for multiplexing an iron core magnetic circuit.

### BACKGROUND

Since the discovery of Faraday's law of electromagnetic induction and Ampere's loop law, motors, transformers, electromagnets and reactors are invented. Since the discovery of electromagnetic waves, radio and radio antennas are invented.

In China, a hybrid internal-combustion engine, a hybrid power train, a high-speed maglev train, a marine electric power integrated system and electric propulsion system, a hybrid-electric aircraft and an pure-electric aircraft are determined as key research projects, providing requirements for further use of power electromagnetic fields and signal electromagnetic waves.

However, no invention integrating a motor, a transformer, an electromagnet, a reactor and an antenna is provided to realize multi-function expansion and integrated applications.

### SUMMARY

A method for multiplexing an iron core magnetic circuit is provided according to the present disclosure. According to the method, an iron core magnetic circuit is multiplexed as a common channel for a power electromagnetic field of a periodic function, a signal electromagnetic wave of the periodic function, and a combination of the power electromagnetic field and the signal electromagnetic wave, and then an iron core hyperspace is constructed. The iron core hyperspace may contain one or more of power electromagnetic fields and signal electromagnetic waves, so that the iron core serves as a carrier of a multi-function channel, realizing multi-function expansion and integrated applications.

In a first aspect, a method for multiplexing an iron core magnetic circuit is provided according to the present disclosure. The method includes: using an iron core as a magnetic circuit multiplexing channel for a power electromagnetic field of a periodic function, a signal electromagnetic wave of the periodic function, and a combination of the power electromagnetic field and the signal electromagnetic wave; and constructing an iron core hyperspace based on the magnetic circuit multiplexing channel, where the iron core hyperspace can contain one or more of power electromagnetic fields and signal electromagnetic waves.

In an embodiment, frequencies, amplitudes, and phases of the one or more of power electromagnetic fields and signal electromagnetic waves are freely transmitted in the magnetic circuit multiplexing channel.

In an embodiment, the magnetic circuit multiplexing channel is applied to a motor. The motor includes one or more windings, and the number of the motor is one or more.

In an embodiment, the magnetic circuit multiplexing channel is applied to a transformer. The transformer includes one or more windings, and the number of the transformer is one or more.

In an embodiment, the magnetic circuit multiplexing channel is applied to an electromagnet. The electromagnet includes one or more windings, and the number of the electromagnet is one or more.

In an embodiment, the magnetic circuit multiplexing channel is applied to a reactor. The reactor includes one or more windings, and the number of the reactor is one or more.

In an embodiment, the magnetic circuit multiplexing channel is applied to an antenna. The antenna includes one or more windings, and the number of the antenna is one or more.

In an embodiment, the magnetic circuit multiplexing channel is applied to a combination of any two of a motor, a transformer, an electromagnet, a reactor, and an antenna. Each of the motor, the transformer, the electromagnet, the reactor and the antenna includes one or more windings, and each of the number of the motor, the number of the transformer, the number of the electromagnet, the number of the reactor, and the number of the antenna is one or more.

In an embodiment, the magnetic circuit multiplexing channel is applied to a combination of any three of a motor, a transformer, an electromagnet, a reactor and an antenna. Each of the motor, the transformer, the electromagnet, the reactor, and the antenna includes one or more windings, and each of the number of the motor, the number of the transformer, the number of the electromagnet, the number of the reactor, and the number of the antenna is one or more.

In an embodiment, the magnetic circuit multiplexing channel is applied to a combination of any four or all of a motor, a transformer, an electromagnet, a reactor, and an antenna. Each of the motor, the transformer, the electromagnet, the reactor, and the antenna includes one or more windings, and each of the number of the motor, the number of the transformer, the number of the electromagnet, the number of the reactor, and the number of the antenna is one or more.

It can be seen that in the method for multiplexing an iron core magnetic circuit according to the present disclosure, the iron core is used as a magnetic circuit multiplexing channel for a power electromagnetic field of a periodic function, a signal electromagnetic wave of the periodic function, and a combination of the power electromagnetic field and the signal electromagnetic wave. An iron core hyperspace is constructed based on the magnetic circuit multiplexing channel, where the iron core hyperspace can contain one or more of power electromagnetic fields and signal electromagnetic waves. Therefore, the iron core magnetic circuit is multiplexed as a common channel for the power electromagnetic field of the periodic function, the signal electromagnetic wave of the periodic function, and the combination of the power electromagnetic field and the signal electromagnetic wave, and then the iron core hyperspace is constructed. The iron core hyperspace can contain one or more of power electromagnetic fields and signal electromagnetic waves, so that the iron core serves as a carrier of a multi-function channel, realizing multi-function expansion and integrated applications.

### BRIEF DESCRIPTION OF THE DRAWINGS

In order to more clearly illustrate the technical solutions of embodiments of the present disclosure or in the conventional technology, drawings to be used in the description of the embodiments of the present disclosure or the conventional technology are briefly described hereinafter. It is apparent that the drawings in the following description show only some embodiments of the present disclosure. Those skilled in the art can obtain other drawings based on these drawings without any creative efforts.

FIG. 1 is a flow chart of a method for multiplexing an iron core magnetic circuit according to the present disclosure;

FIG. 2 is a topology diagram of multiplexing an iron core magnetic circuit on a motor according to the present disclosure;

FIG. 3 is a topology diagram of multiplexing an iron core magnetic circuit on a transformer according to the present disclosure;

FIG. 4 is a topology diagram of multiplexing an iron core magnetic circuit on an electromagnet according to the present disclosure;

FIG. 5 is a topology diagram of multiplexing an iron core magnetic circuit on a reactor according to the present disclosure;

FIG. 6 is a topology diagram of multiplexing an iron core magnetic circuit on an antenna according to the present disclosure; and

FIG. 7 is a topology diagram of multiplexing an iron core magnetic circuit on a motor, a transformer, an electromagnet, a reactor, and an antenna according to the present disclosure.

### DETAILED DESCRIPTION OF THE EMBODIMENTS

A method for multiplexing an iron core magnetic circuit is provided according to the present disclosure. According to the method, an iron core magnetic circuit is multiplexed as a common channel for a power electromagnetic field of a periodic function, a signal electromagnetic wave of the periodic function, and a combination of the power electromagnetic field and the signal electromagnetic wave, and then an iron core hyperspace the power electromagnetic field and the signal electromagnetic wave. The iron core hyperspace may contain one or more of power electromagnetic fields and signal electromagnetic waves, so that the iron core serves as a carrier of a multi-function channel, realizing multi-function expansion and integrated applications.

Technical solutions of embodiments of the present disclosure are clearly and completely described hereinafter in conjunction with the drawings of the embodiments of the present disclosure. Apparently, the described embodiments are only part embodiments of the present disclosure, rather than all embodiments. Other embodiments obtained by those skilled in the art without any creative efforts based on the embodiments of the present disclosure fall within the protection scope of the present disclosure.

It should be noted that all directional indications (such as up, down, left, right, front, back and the like) in the embodiments of the present disclosure are only used to explain a relative position relationship, movements, or the like between components under a particular attitude (as shown in the drawings). If the particular attitude changes, the directional indications change accordingly.

In addition, the descriptions, such as “first” and “second” in the present disclosure are only used for descriptive purposes, and cannot be understood as indicating or implying the relative importance or implicitly indicating the number of indicated technical features. Therefore, features defined with “first” or “second” may include at least one of the features explicitly or implicitly. In the description of the present disclosure, the term “multiple/plurality of” means at least two, such as two, or three, unless clearly defined otherwise.

In the present disclosure, unless clearly specified or defined otherwise, the terms such as “connection” and “fixation” should be understood in a broad sense. For example, “fixation” may be a fixed connection, a detachable connection, or connection as an integral, may be a mechanical connection or an electrical connection, may be a direct connection, an indirect connection via an intermediate medium, or internal communication between two components or interaction relationship between two components, unless clearly defined otherwise. Those skilled in the art may understand meanings of the foregoing terms in the present disclosure according to specific conditions.

In addition, the technical solutions between the embodiments of the present disclosure may be combined with each other, but the combination should be based on the realization by those skilled in the art. When a combination of technical solutions is contradictory or cannot be realized, it should be considered that the combination of the technical solutions does not exist, and does not fall within the protection scope of the present disclosure.

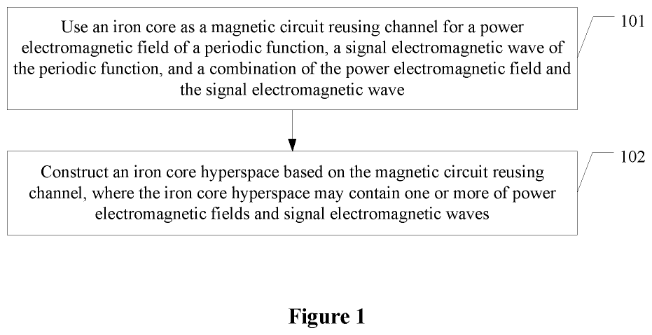

As shown in FIG. 1, a method for multiplexing an iron core magnetic circuit is provided according to an embodiment of the present disclosure. The method includes the following steps 101 and 102.

In step 101, an iron core is used as a magnetic circuit multiplexing channel for a power electromagnetic field of a periodic function, a signal electromagnetic wave of the periodic function, and a combination of the power electromagnetic field and the signal electromagnetic wave.

In step 102, an iron core hyperspace is constructed based on the magnetic circuit multiplexing channel. The iron core hyperspace may contain one or more of power electromagnetic fields and signal electromagnetic waves.

According to the method for multiplexing an iron core magnetic circuit in the embodiment of the present disclosure, the iron core is used as a magnetic circuit multiplexing channel for a power electromagnetic field of a periodic function, a signal electromagnetic wave of the periodic function, and a combination of the power electromagnetic field and the signal electromagnetic wave. An iron core hyperspace is constructed based on the magnetic circuit multiplexing channel, where the iron core hyperspace can contain one or more of power electromagnetic fields and signal electromagnetic waves. Therefore, the iron core magnetic circuit is multiplexed as a common channel for the power electromagnetic field of the periodic function, the signal electromagnetic wave of the periodic function, and the combination of the power electromagnetic field and the signal electromagnetic wave, and then the iron core hyperspace is constructed. The iron core hyperspace can contain one or more of power electromagnetic fields and signal electromagnetic waves, so that the iron core serves as a carrier of a multi-function channel, realizing multi-function expansion and integrated applications.

In an embodiment, frequencies, amplitudes, and phases of the one or more of power electromagnetic fields and signal electromagnetic waves may be freely transmitted in the magnetic circuit multiplexing channel. That is, the constructed iron core hyperspace may contain an infinite variety of power electromagnetic fields and signal electromagnetic waves, without the problem of “collisions” and channel congestion in a physical space.

Based on the above method for multiplexing an iron core magnetic circuit in the present disclosure, an iron core is used as a magnetic circuit multiplexing channel for a power electromagnetic field of a periodic function, a signal electromagnetic wave of the periodic function, and a combination of the power electromagnetic field and the signal electromagnetic wave in practices, changing the conventional idea of simply using an iron core as a transmission channel for sinusoidal electromagnetic fields, PWM power electromagnetic fields, and signal electromagnetic waves in motors, transformers, electromagnets, reactors and antennas, and thereby infinitely expanding the reusability of the iron core magnetic circuit.

The magnetic circuit multiplexing channel is applied to one of the motor, the transformer, the electromagnet, the reactor and the antenna, or a combination thereof.

The method according to the present disclosure may be applied to an asynchronous motor, a synchronous motor, a rotary motor, a linear motor, a reciprocating motion motor, a motor with customized motion features, an electrically excited motor, a permanent magnet motor, a combination of the electrically excited motor and the permanent magnet motor, a transformer, an electromagnet, a reactor, and a special communication antenna.

The method according to the present disclosure is not applicable to an application without an iron core.

Unless following the design concept of the present disclosure, the method is not applicable to normal applications such as a power-frequency motor, a power-frequency transformer, a power-frequency reactor, and a public telecommunications wireless communication antenna.

Hereinafter, the present disclosure is described in detail with specific embodiments.

In a first embodiment, the magnetic circuit multiplexing channel is applied to a motor. The motor includes one or more windings. The number of the motor is one or more.

For multiplexing an iron core magnetic circuit on a generator, electrically independent power supplies, with different numbers of circuits and different voltage levels, may be obtained. The power supplies may be single-phase power supplies, three-phase power supplies and multi-phase power supplies, and may supply power to different loads.

According to the Fourier transform, the obtained power supplies and load features are determined based on inputted generator features. Based on the inputted generator features, the power supplies to be obtained and the load features are determined.

For multiplexing an iron core magnetic circuit on a motor, a way for multiple power supplies, with different voltages, currents, frequencies and waveforms, jointly driving a same mechanical load is provided. The motor may be an asynchronous motor, a synchronous motor, a rotary motor, or a linear motor.

According to the inverse Fourier transform, various required mechanical features may be generated by performing magnetic field coupling based on power features of different transfer functions.

The mechanical features may include a forward rotation feature, a braking feature, a locked rotor feature, a reverse rotation feature, a stepping feature, an X steps forward and Y steps backward feature, a reciprocating motion feature, a vibration feature, an impact feature, and other movement features.

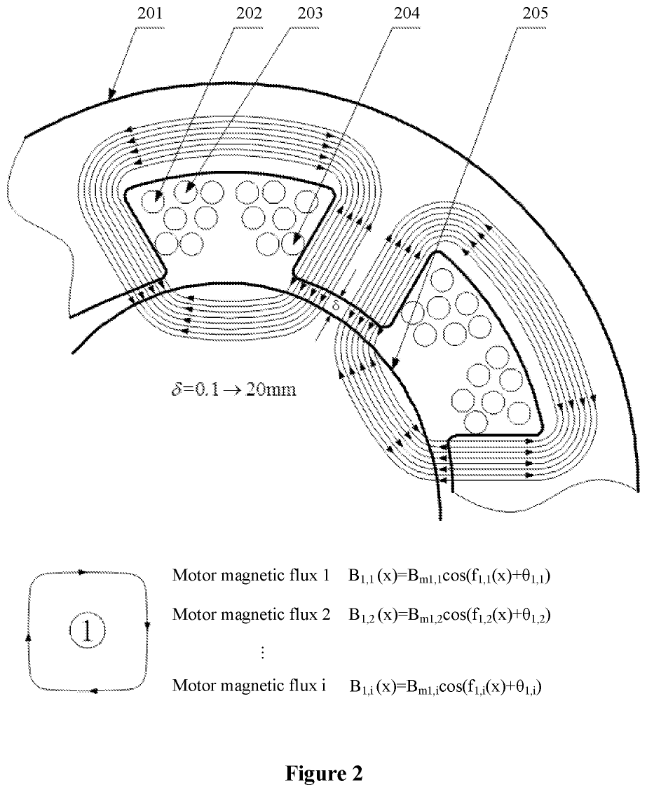

Reference is made to FIG. 2, which is a topology diagram of multiplexing an iron core magnetic circuit on a motor. In FIG. 2, 201 represents a stator iron core of the motor, 205 represents a rotor iron core, 202 represents a traction winding 1 of the motor, 203 represents a traction winding 2 of the motor, and 204 represents a traction winding i′ of the motor. In a case that an air gap δ ranges from 0.1 mm to 20 mm, i′ traction windings of the motor are connected to a power supply with a specific waveform to generate i motor magnetic fluxes, where i and i′ represent natural numbers greater than or equal to 0. A total magnetic flux of i motor magnetic fluxes with multiplexing a magnetic circuit in the iron core is expressed as:

$${B}_{1} ( x ) = {\sum }_{i = 1}^{∞} {B}_{m 1 , i} cos ( {f}_{1 , i} ( x ) + {θ}_{1 , i} )$$

The i motor magnetic fluxes form multiplexing the magnetic circuit in the iron core. In a case that a magnetic field generated by multiplexing the magnetic circuit meets a magnetic field requirement of a rotary motor and an iron core in a specific shape and a transmission device are arranged, the device may perform the function of the rotary motor and perform mutual conversion between mechanical energy and electrical energy. In a case that the magnetic field generated by multiplexing the magnetic circuit meets a magnetic field requirement of a linear motor and the iron core in a specific shape and a transmission device is arranged, the device may perform the function of the linear motor and perform the mutual conversion between mechanical energy and electrical energy.

In a second embodiment, the magnetic circuit multiplexing channel is applied to a transformer. The transformer includes one or more windings. The number of the transformer is one or more.

For multiplexing an iron core magnetic circuit on a transformer, a way for multiple power supplies, with different voltages, currents, frequencies and waveforms, jointly driving a same energy conversion is provided. The transformer may be a single-phase transformer or a multi-phase transformer.

According to the inverse Fourier transform, the sum of the power supplies determines input features of the transformer. The output and the load features are determined based on the input. Various required magnetic fields may be generated by performing magnetic field coupling based on power features of different transfer functions.

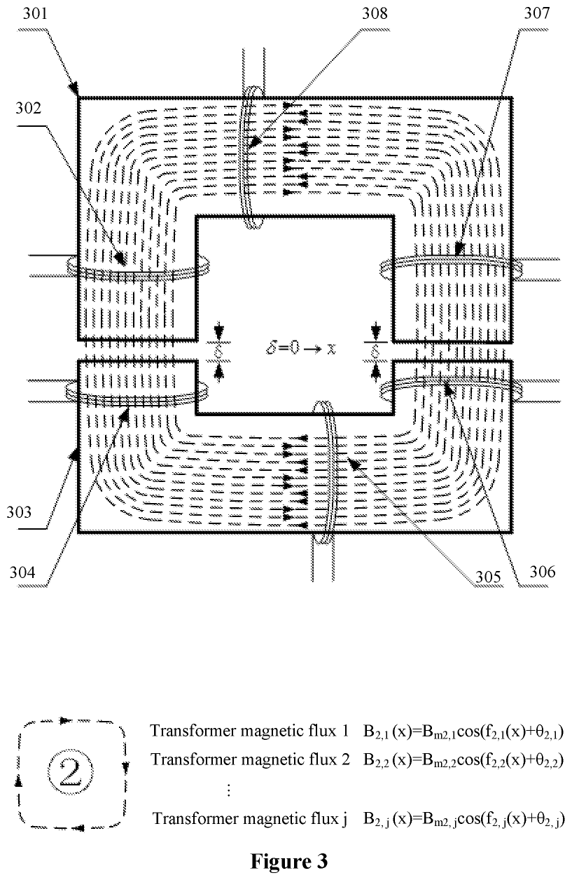

Reference is made to FIG. 3, which is a topology diagram of multiplexing an iron core magnetic circuit on a transformer. In FIG. 3, 301 represents a primary iron core of the transformer, 302 represents a primary winding 1 of the transformer, 303 represents a secondary iron core of the transformer, 304 represents a secondary winding 1 of the transformer, 305 represents a secondary winding 2 of the transformer, 306 represents a secondary winding j″ of the transformer, 307 represents a primary winding j′ of the transformer, and 308 represents a primary winding 2 of the transformer. In a case that an air gap δ ranges from Omm to x, j windings are connected to a power supply with a specific waveform to generate j transformer magnetic fluxes, where j, j′ and j″ represent natural numbers greater than or equal to 0. A total magnetic flux of j transformer magnetic fluxes with multiplexing a magnetic circuit in the iron core is expressed as:

$${B}_{2} ( x ) = {\sum }_{j = 1}^{∞} {B}_{m 2 , j} cos ( {f}_{2 , j} ( x ) + {θ}_{2 , j} )$$

The j transformer magnetic fluxes form multiplexing the magnetic circuit in the iron core. In a case that a magnetic field generated by multiplexing the magnetic circuit meets an energy conversion requirement of a transformer and an iron core in a specific shape and a transmission device are arranged, the device may perform energy conversion.

In a third embodiment, the magnetic circuit multiplexing channel is applied to an electromagnet. The electromagnet includes one or more windings. The number of the electromagnet is one or more.

For multiplexing an iron core magnetic circuit on an electromagnet, a way for multiple power supplies, with different voltages, currents, frequencies and waveforms, jointly driving a same electromagnetic mechanism is provided. The electromagnet may be a suspension electromagnet, a guide electromagnet, an eddy current braking electromagnet, an entrance guard electromagnet, or the like.

According to the Fourier transform, various required electromagnetic transmission features may be generated by performing magnetic field coupling based on power features of different transfer functions.

Based on the electromagnetic transmission features, a device may be suspended, a direction of a moving body may be guided, a moving body may be braked, and a suction operation may be performed.

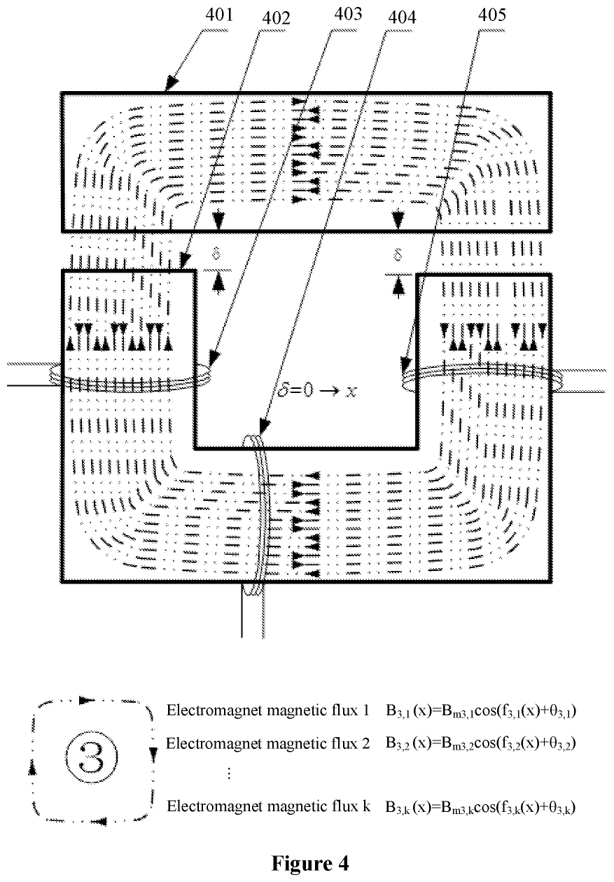

Reference is made to FIG. 4, which is a topology diagram of multiplexing an iron core magnetic circuit on an electromagnet. In FIG. 4, 401 represents an iron core of the electromagnet, 402 represents an iron core of the electromagnet, 403 represents a winding 1 of the electromagnet, 404 represents a winding 2 of the electromagnet, and 405 represents a winding k′ of the electromagnet. In a case that an air gap δ ranges from Omm to x, k′ windings of the electromagnet are connected to a power supply with a specific waveform to generate k electromagnetic fluxes, where k and k′ represent natural numbers greater than or equal to 0. A total magnetic flux of k transformer magnetic fluxes with multiplexing a magnetic circuit in the iron core is expressed as:

$${B}_{3} ( x ) = {\sum }_{k = 1}^{∞} {B}_{m 3 , k} cos ( {f}_{3 , k} ( x ) + {θ}_{3 , k} )$$

The k transformer magnetic fluxes form multiplexing the magnetic circuit in the iron core. In a case that a magnetic field generated by multiplexing the magnetic circuit meets an operation requirement of an electromagnet and an iron core in a specific shape and a transmission device are arranged, the device may perform energy conversion.

In a fourth embodiment, the magnetic circuit multiplexing channel is applied to a reactor. The reactor includes one or more windings. The number of the reactor is one or more.

For multiplexing an iron core magnetic circuit on a reactor, a way for multiple power supplies, with different voltages, currents, frequencies and waveforms, jointly driving a same electromagnetic mechanism is provided. The reactor may be a single-phase reactor or a multi-phase reactor.

According to the Fourier transform, various required electromagnetic fluxes may be generated by performing magnetic field coupling based on power features of different transfer functions. By performing magnetic circuit multiplexing, functions, such as reactive power compensation, overvoltage limitation and overcurrent limitation, may be performed. Based on special designs, it is ensured that a magnetic circuit is not saturated when all units operate at a full load. In such way, the magnetic circuit is not saturated when one unit or multiple units operate, avoiding the problem of “collisions” and channel congestion in a physical space.

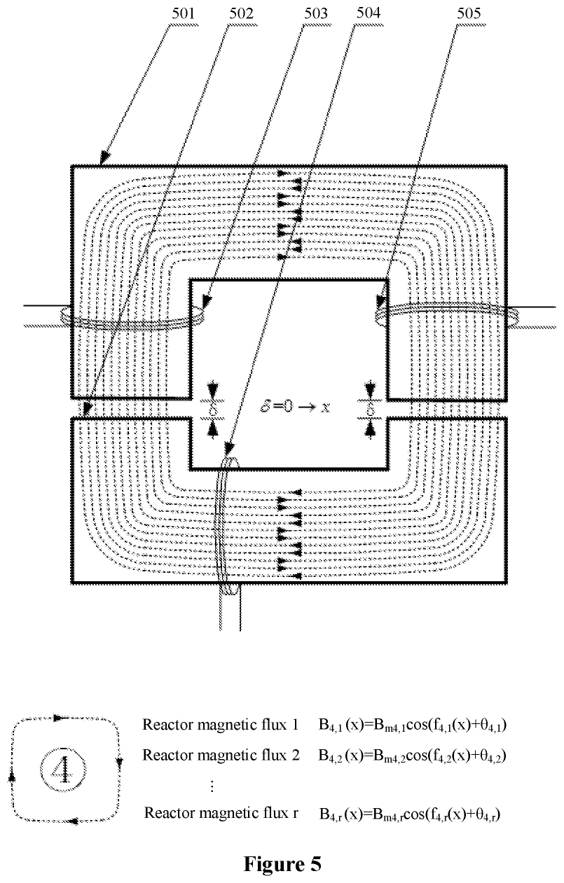

Reference is made to FIG. 5, which is a topology diagram of multiplexing an iron core magnetic circuit on a reactor. In FIG. 5, 501 represents an iron core of the reactor, 502 represents an iron core of the reactor, 503 represents a winding 1 of the reactor, 504 represents a winding 2 of the reactor, and 505 represents a winding r′ of the reactor. In a case that an air gap δ ranges from 0 mm to x, r′ windings of the reactor are connected to a power supply with a specific waveform to generate r reactor magnetic fluxes, where r and r′ represent natural numbers greater than or equal to 0. A total magnetic flux of r reactor magnetic fluxes with multiplexing a magnetic circuit in the iron core is expressed as:

$${B}_{4} ( x ) = {\sum }_{r = 1}^{∞} {B}_{m 4 , r} cos ( {f}_{4 , r} ( x ) + {θ}_{4 , r} )$$

The r reactor magnetic fluxes form multiplexing the magnetic circuit in the iron core. In a case that a magnetic field generated by multiplexing the magnetic circuit meets an operation requirement of a reactor and an iron core in a specific shape and a transmission device are arranged, the device may perform the functions, such as reactive power compensation, overvoltage limitation and overcurrent limitation.

In a fifth embodiment, the magnetic circuit multiplexing channel is applied to an antenna. The antenna includes one or more windings. The number of the antenna is one or more.

For multiplexing an iron core magnetic circuit on an antenna, a way for multiple power supplies, with different voltages, currents, frequencies and waveforms, jointly driving a same electromagnetic wave transmission is provided.

According to the Fourier transform, various required electromagnetic waves may be generated by performing magnetic field coupling based on power features of different transfer functions. A signal is transmitted by multiplexing a magnetic circuit. The transmitted signal may be a communication signal, a control signal, or the like.

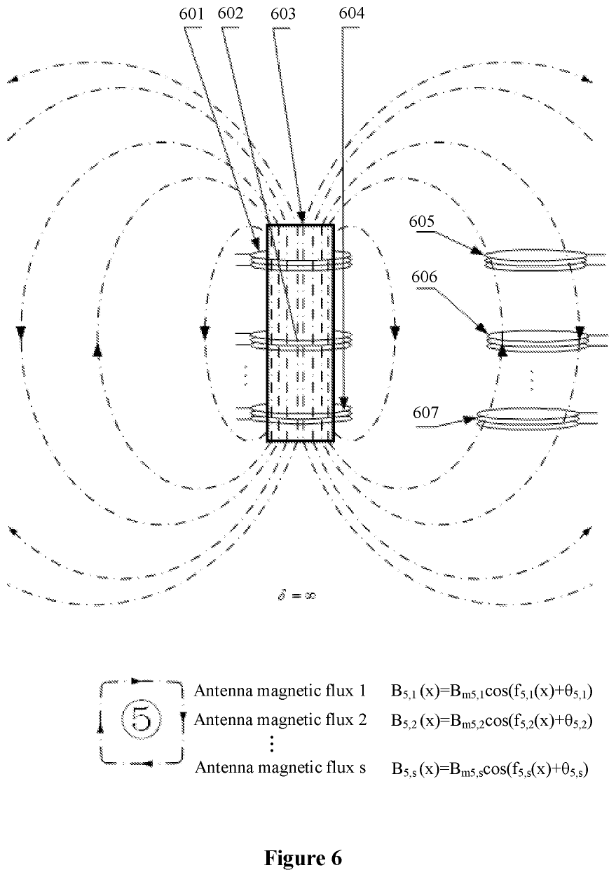

Reference is made to FIG. 6, which is a topology diagram of multiplexing an iron core magnetic circuit on an antenna. In FIG. 6, 601 represents a transmission coil 1 of the antenna, 602 represents a transmission coil 2 of the antenna, 603 represents an iron core of the antenna, 604 represents a transmission coil s′ of the antenna, 605 represents a reception coil 1 of the antenna, 606 represents a reception coil 2 of the antenna, and 607 represents a reception coil s′ of the antenna. In a case that an air gap δ is ∞, s′ transmission coils of the reactor are connected to a power supply with a specific waveform to be excited to generate s antenna magnetic fluxes, where s, s′ and s″ represent natural numbers greater than or equal to 0. A total magnetic flux of the s antenna magnetic fluxes with multiplexing a magnetic circuit in the iron core is expressed as:

$${B}_{5} ( x ) = {\sum }_{s = 1}^{∞} {B}_{m 5 , s} cos ( {f}_{5 , s} ( x ) + {θ}_{5 , s} )$$

The s antenna magnetic fluxes form multiplexing the magnetic circuit in the iron core. In a case that a magnetic field generated by multiplexing the magnetic circuit conforms to a signal emission rule and an iron core in a specific shape and a transmission device are arranged, the device may perform electromagnetic wave emission, electromagnetic wave transmission and electromagnetic wave reception.

In a sixth embodiment, the magnetic circuit multiplexing channel is applied to a combination of any two of a motor, a transformer, an electromagnet, a reactor and an antenna. Each of the motor, the transformer, the electromagnet, the reactor and the antenna includes one or more windings. Each of the number of the motor, the number of the transformer, the number of the electromagnet, the number of the reactor, and the number of the antenna is one or more.

There are the following ten combinations: a combination of the motor and the transformer, a combination of the motor and the electromagnet, a combination of the motor and the reactor, a combination of the motor and the antenna, a combination of the transformer and the electromagnet, a combination of the transformer and the reactor, a combination of the transformer and the antenna, a combination of the electromagnet and the reactor, a combination of the electromagnet and the antenna, and a combination of the reactor and the antenna. For the descriptions of applying the magnetic circuit multiplexing channel to the motor, the transformer, the electromagnet, the reactor or the antenna, one may refer to the above descriptions in the first embodiment, the second embodiment, the third embodiment, the fourth embodiment and the fifth embodiment.

In a seventh embodiment, the magnetic circuit multiplexing channel is applied to a combination of any three of a motor, a transformer, an electromagnet, a reactor and an antenna. Each of the motor, the transformer, the electromagnet, the reactor and the antenna includes one or more windings. Each of the number of the motor, the number of the transformer, the number of the electromagnet, the number of the reactor and the number of the antenna is one or more.

There are the following ten combinations: a combination of the motor, the transformer and the electromagnet, a combination of the motor, the transformer and the reactor, a combination of the motor, the transformer and the antenna, a combination of the motor, the electromagnet and the reactor, a combination of the motor, the electromagnet and the antenna, a combination of the motor, the reactor and the antenna, a combination of the transformer, the electromagnet and the reactor, a combination of the transformer, the electromagnet and the antenna, a combination of the transformer, the reactor and the antenna, and a combination of the electromagnet, the reactor and the antenna. For the descriptions of applying the magnetic circuit multiplexing channel to the motor, the transformer, the electromagnet, the reactor or the antenna, one may refer to the above descriptions in the first embodiment, the second embodiment, the third embodiment, the fourth embodiment and the fifth embodiment.

In an eighth embodiment, the magnetic circuit multiplexing channel is applied to a combination of any four of a motor, a transformer, an electromagnet, a reactor, and an antenna. Each of the motor, the transformer, the electromagnet, the reactor and the antenna includes one or more windings. Each of the number of the motor, the number of the transformer, the number of the electromagnet, the number of the reactor, and the number of the antenna is one or more.

There are the following five combinations: a combination of the motor, the transformer, the electromagnet and the reactor, a combination of the motor, the transformer, the electromagnet and the antenna, a combination of the motor, the transformer, the electromagnet and the reactor, a combination of the motor, the electromagnet, the reactor and the antenna, and a combination of the transformer, the electromagnet, the reactor and the antenna. For the descriptions of applying the magnetic circuit multiplexing channel to the motor, the transformer, the electromagnet, the reactor or the antenna, one may refer to the above descriptions in the first embodiment, the second embodiment, the third embodiment, the fourth embodiment and the fifth embodiment.

In a ninth embodiment, the magnetic circuit multiplexing channel is applied to a combination of a motor, a transformer, an electromagnet, a reactor and an antenna. Each of the motor, the transformer, the electromagnet, the reactor and the antenna includes one or more windings. Each of the number of the motor, the number of the transformer, the number of the electromagnet, the number of the reactor and the number of the antenna is one or more.

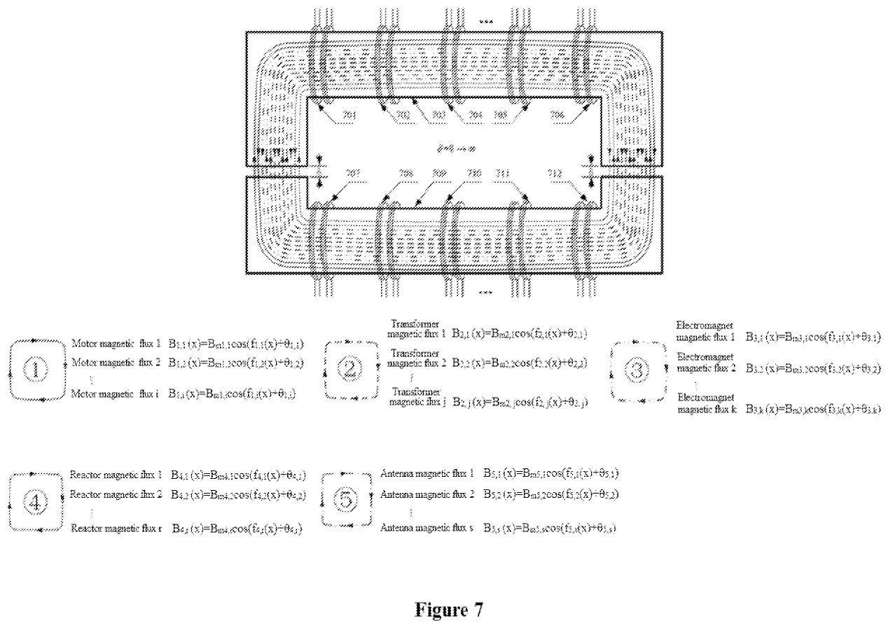

Reference is made to FIG. 7, which is a topology diagram of multiplexing an iron core magnetic circuit on a motor, a transformer, an electromagnet, a reactor and an antenna. In FIG. 7, 701 represents i′ windings of the motor, 702 represents j′ windings of the transformer, 703 represents an iron core, 704 represents k′ windings of the electromagnet, 705 represents r′ windings of the reactor, 706 represents s′ coils of the antenna, 707 represents i″ windings of the motor, 708 represents j″ windings of the transformer, 709 represents an iron core, 710 represents k″ windings of the electromagnet, 711 represents r″ windings of the reactor, and 712 represents s″ coils of the antenna, where i, j, k, r, s, i′, j′, k′, r′, s′, i″, j″, k″, r″ and s″ represent natural numbers greater than or equal to 0.

The iron core magnetic circuit is multiplexed in a combination of the motor, the transformer, the electromagnet, the reactor and the antenna. Windings of the motor, the transformer, the electromagnet, the reactor and the antenna are connected to a power supply with a specific waveform to generate i motor magnetic fluxes, j transformer magnetic fluxes, k electromagnet magnetic fluxes, r reactor magnetic fluxes, and s antenna magnetic fluxes. A total magnetic flux and electromagnetic wave in the iron core with multiplexing a magnetic circuit is expressed as:

$$B ( x ) = {\sum }_{i = 1}^{∞} {B}_{m 1 , i} cos ( {f}_{1 , i} ( x ) + {θ}_{1 , i} ) + {\sum }_{j = 1}^{∞} {B}_{m 2 , j} cos ( {f}_{2 , j} ( x ) + {θ}_{2 , j} ) + {\sum }_{k = 1}^{∞} {B}_{m 3 , k} cos ( {f}_{3 , k} ( x ) + {θ}_{3 , k} ) + {\sum }_{r = 1}^{∞} {B}_{m 4 , r} cos ( {f}_{4 , r} ( x ) + {θ}_{4 , r} ) + {\sum }_{s = 1}^{∞} {B}_{m 5 , s} cos ( {f}_{5 , s} ( x ) + {θ}_{5 , s} )$$

Functions corresponding to different magnetic circuits are constructed according to detail requirements. The magnetic circuit is multiplexed in the iron core, an iron core in a specific shape and a transmission device are arranged, then the device may perform conversion between mechanical energy and electrical energy, conversion between different electrical energy forms, and emission, transmission and reception of electromagnetic waves. The iron core with a multiplexed magnetic circuit serves as the motor, the transformer, the reactor, the electromagnet and the antenna, performing multi-function extension and integrated application of the motor, the transformer, the reactor, the electromagnet and the antenna.

The embodiments in this specification are described in a progressive way, each of the embodiments emphasizes the differences from others, and the same or similar parts among the embodiments may be referred to each other. Since the device disclosed in the embodiments corresponds to the method disclosed in the embodiments, the description thereof is relatively simple, and relevant parts may refer to the descriptions of the method.

It should be noted that terms of “include”, “comprise” or any other variants are intended to be non-exclusive. Therefore, a process, method, article or device including a series of elements includes not only the elements but also other elements that are not clearly enumerated, or also includes the elements inherent for the process, method, article or device. Unless expressively limited otherwise, the statement “comprising (including) one . . . ” does not exclude the case that other similar elements may exist in the process, method, article or device other than enumerated elements.

Based on the above description of the disclosed embodiments, those skilled in the art can implement or practice the present disclosure. Various modifications to the embodiments are apparent to those skilled in the art. The general principles defined in the present disclosure may be implemented in other embodiments without departing from the spirit or scope of the present disclosure. Therefore, the present disclosure is not limited to the embodiments described herein, and conforms to the widest scope consistent with the principle and novel features disclosed herein.

1. A method for multiplexing an iron core magnetic circuit, comprising:
using an iron core as a magnetic circuit multiplexing channel for a power electromagnetic field of a periodic function, a signal electromagnetic wave of the periodic function, and a combination of the power electromagnetic field and the signal electromagnetic wave; and
constructing an iron core hyperspace based on the magnetic circuit multiplexing channel, wherein the iron core hyperspace is capable of containing one or more of power electromagnetic fields and signal electromagnetic waves.

2. The method according to claim 1, wherein frequencies, amplitudes, and phases of the one or more of power electromagnetic fields and signal electromagnetic waves are freely transmitted in the magnetic circuit multiplexing channel.

3. The method according to claim 1, wherein the magnetic circuit multiplexing channel is applied to a motor, the motor comprises one or more windings, and the number of the motor is one or more.

4. The method according to claim 1, wherein the magnetic circuit multiplexing channel is applied to a transformer, the transformer comprises one or more windings, and the number of the transformer is one or more.

5. The method according to claim 1, wherein the magnetic circuit multiplexing channel is applied to an electromagnet, the electromagnet comprises one or more windings, and the number of the electromagnet is one or more.

6. The method according to claim 1, wherein the magnetic circuit multiplexing channel is applied to a reactor, the reactor comprises one or more windings, and the number of the reactor is one or more.

7. The method according to claim 1, wherein the magnetic circuit multiplexing channel is applied to an antenna, the antenna comprises one or more windings, and the number of the antenna is one or more.

8. The method according to claim 1, wherein the magnetic circuit multiplexing channel is applied to a combination of any two of a motor, a transformer, an electromagnet, a reactor and an antenna, each of the motor, the transformer, the electromagnet, the reactor and the antenna comprises one or more windings, and each of the number of the motor, the number of the transformer, the number of the electromagnet, the number of the reactor, and the number of the antenna is one or more.

9. The method according to claim 1, wherein the magnetic circuit multiplexing channel is applied to a combination of any three of a motor, a transformer, an electromagnet, a reactor and an antenna, each of the motor, the transformer, the electromagnet, the reactor and the antenna comprises one or more windings, and each of the number of the motor, the number of the transformer, the number of the electromagnet, the number of the reactor, and the number of the antenna is one or more.

10. The method according to claim 1, wherein the magnetic circuit multiplexing channel is applied to a combination of any four or all of a motor, a transformer, an electromagnet, a reactor and an antenna, each of the antenna, the motor, the transformer, the electromagnet, the reactor and the antenna comprises one or more windings, and each of the number of the motor, the number of the transformer, the number of the electromagnet, the number of the reactor, and the number of the antenna is one or more.
